(19) United States
(12) Patent Application Publication
(10) Pub. No.: US 2004/0044148 A1
(43) Pub. Date: Mar. 4, 2004

(54) Method for preactivating catalysts

(76) Inventors: Wolfgang Bidell, Belgium (DE); Joachim Zitzmann, Maxdorf (DE); John Lynch, Monsheim (DE); Juergen Oelze, Ludwigshafen (DE); Hermann Gebhart, Bohl-Iggelheim (DE)

Correspondence Address: KEIL & WEINKAUF, 1350 CONNECTICUT AVENUE, N.W., WASHINGTON, DC, 20036, US

(21) Appl. No.: 10/380,549

(22) PCT Filed: Sep. 20, 2001
(86) PCT No.: PCT/EP01/10847

(30) Foreign Application Priority Data
Sep. 26, 2000 (EP) 100 48 003.9

(51) Int. Cl. C08F 2/00; C08F 4/44

(52) U.S. Cl. 526/64; 526/124.3; 526/901; 422/131

(57) ABSTRACT

Catalysts for the polymerization of C₂-C₂₀-olefins are preactivated by a process in which the catalyst is first mixed with the respective monomer, then, if appropriate, the respective cocatalyst is added and the resulting mixture is subsequently subjected to preactivation in a tube reactor and the catalyst which has been preactivated in this way is finally introduced into the actual polymerization reactor, wherein the mixture of catalyst, any cocatalyst and monomer is passed through the tube reactor in turbulent plug flow at a Reynolds number of at least 2 300.

The present invention relates to a process for preactivating catalysts for the polymerization of C₂-C₂₀-olefins, in which the catalyst is first mixed with the respective monomer, then, if appropriate, the respective cocatalyst is added and the resulting mixture is subsequently subjected to preactivation in a tube reactor and the catalyst which has been preactivated in this way is finally introduced into the actual polymerization reactor, wherein the mixture of catalyst, any cocatalyst and monomer is passed through the tube reactor in turbulent plug flow at a Reynolds number of at least 2 300.

The present invention additionally relates to an apparatus for preactivating catalysts which are suitable for the polymerization of C₂-C₂₀-olefins.

Polymers of C₂-C₁₀-olefins can be prepared both by liquid-phase polymerization and by polymerization in a slurry or by gas-phase polymerization. Since the solid polymer formed can easily be separated from the gaseous reaction mixture, polymerization is increasingly carried out from the gas phase. In this case, the polymerization is carried out with the aid of a Ziegler-Natta catalyst system which customarily comprises a titanium-containing solid component, an organic aluminum compound and an organic silane compound (EP-B 45 977, EP-A 171 200, U.S. Pat. No. 4,857,613, U.S. Pat. No. 5,288,824).

The polymers of C₂-C₁₀-olefins include the corresponding homopolymers, copolymers and block or high-impact copolymers. The latter are usually mixtures of various homopolymers or copolymers of C₂-C₁₀-alk-1-enes which have, in particular, a good impact toughness. They are usually prepared in reactor cascades comprising at least two reactors connected in series and often in an at least two-stage process in which the polymer obtained in a first reactor is transferred in the presence of still active Ziegler-Natta catalyst constituents to a second reactor in which further monomers are polymerized onto the polymer from the first reactor.

If catalysts having a high productivity are used in the preparation of polymers of C₂-C₂₀-olefins, problems in respect of the morphology of the polymer obtained, in particular a high proportion of fines and formation of lumps in the reactor, are observed, especially in industrial-scale plants. Furthermore, the productivity in such industrial-scale plants is frequently reduced compared to smaller plants. Such problems can be solved by, inter alia, subjecting the polymerization catalyst to a prepolymerization under mild conditions before it is fed into the actual polymerization reactor. Such a prepolymerization can be carried out either in a batch reactor or else in a continuously operating stirred reactor (WO 97/33920). It is also possible to allow the prepolymerization to proceed continuously in a loop reactor (WO 95/22565, EP-A 574821, EP-A 560312, WO 98/55519). In the case of a prepolymerization in a loop reactor, problems in respect of storage and productivity of the prepolymerized catalyst frequently occur.

It is known from WO 97/33920 that difficulties occurring in the prepolymerization can be alleviated by carrying out the prepolymerization in a very long tube reactor. However, such a long tube reactor is unsuitable for high productivities and long reactor running times, since such a tube reactor is difficult to regulate and the risk of the reactor becoming blocked cannot be ruled out. According to EP-A 279 153, blockage of a tube reactor used for the prepolymerization can be significantly decreased by reducing the average residence time in the tube reactor to less than 1 minute.

It is an object of the present invention to remedy the abovementioned disadvantages and to develop a novel process for preactivating catalysts for the polymerization of C₂-C₂₀-olefins, which process has an increased productivity and process stability over a very long period of time and leads to polymers having an improved morphology.

We have found that this object is achieved by a novel process for preactivating catalysts for the polymerization of C₂-C₂₀-olefins, in which the catalyst is first mixed with the respective monomer, then, if appropriate, the respective cocatalyst is added and the resulting mixture is subsequently subjected to preactivation in a tube reactor and the catalyst which has been preactivated in this way is finally introduced into the actual polymerization reactor, wherein the mixture of catalyst, any cocatalyst and monomer is passed through the tube reactor in turbulent plug flow at a Reynolds number of at least 2 300.

C₂-C₂₀-Olefins which can be used in the process of the present invention are, in particular, C₂-C₂₀-alk-1-enes such as ethylene, propylene, 1-butene, 1-pentene, 1-hexene, 1-heptene or 1-octene, with preference being given to using ethylene, propylene or 1-butene. Furthermore, the term C₂-C₂₀-olefins used in the context of the present invention also encompasses internal C₄-C₂₀-olefins such as 2-butene or isoprene, C₄-C₂₀-dienes such as 1,4-butadiene, 1,5-hexadiene, 1,9-decadiene, 5-ethylidene-2-norbornene, 5-methylidene-2-norbornene, also cyclic olefins such as norbornene or α-pinene or else trienes such as 1,6-diphenyl-1,3,5-hexatriene, 1,6-di-tert-butyl-1,3,5-hexatriene, 1,5,9-cyclododecatriene, trans,trans-farnesol, and also multiply unsaturated fatty acids or fatty acid esters. The process is suitable for the preparation of homopolymers of C₂-C₂₀-olefins or of copolymers of C₂-C₂₀-olefins, preferably with up to 30% by weight of other copolymerized olefins having up to 20 carbon atoms. For the purposes of the present invention, the term copolymers encompasses both random copolymers and block or high-impact copolymers.

In general, the process of the present invention for preactivating polymerization catalysts is carried out in at least one reaction zone, frequently in two or more reaction zones, i.e. the polymerization conditions differ between the reaction zones so that polymers having different properties are produced. In the case of homopolymers or random copolymers, this can be, for example, the molar mass, i.e. polymers having different molar masses are produced in the reaction zones to broaden the molar mass distribution. Preference is given to polymerizing different monomers or monomer compositions in the reaction zones. This then usually leads to block or high-impact copolymers.

The process of the present invention is particularly useful for preparing homopolymers of propylene or copolymers of propylene with up to 30% by weight of other copolymerizable olefins having up to 10 carbon atoms. The copolymers of propylene are random copolymers or block or high-impact copolymers. If the copolymers of propylene have a random structure, they generally contain up to 15% by weight, preferably up to 6% by weight, of other olefins having up to 10 carbon atoms, in particular ethylene, 1-butene or a mixture of ethylene and 1-butene.

The block or high-impact copolymers of propylene are polymers in which a propylene homopolymer or a random copolymer of propylene with up to 15% by weight, preferably up to 6% by weight, of other olefins having up to 10 carbon atoms is prepared in the first step and then, in the second step, a propylene-ethylene copolymer which has an ethylene content of from 15 to 99% by weight and may further comprise additional C₄-C₁₀-olefins is polymerized onto the initial polymer. In general, the amount of propylene-ethylene copolymer polymerized onto the initial polymer is such that the copolymer produced in the second step makes up from 3 to 90% by weight of the final product.

Catalysts which can be used include, inter alia, Phillips catalysts based on chromium compounds or Ziegler catalysts. The polymerization can also, for example, be carried out by means of a Ziegler-Natta catalyst system. In particular, use is made of catalyst systems which comprise a titanium-containing solid component a) together with cocatalysts in the form of organic aluminum compounds b) and electron donor compounds c).

However, the process of the present invention can also be carried out using Ziegler-Natta catalyst systems based on metallocene compounds or based on polymerization-active metal complexes.

Titanium compounds used for preparing the titanium-containing solid component a) are generally the halides or alkoxides of trivalent or tetravalent titanium, with it also being possible to use titanium alkoxide halide compounds or mixtures of various titanium compounds. Preference is given to using the titanium compounds containing chlorine as halogen. Preference is likewise given to titanium halides which contain only titanium and halogen, especially the titanium chlorides and in particular titanium tetrachloride.

The titanium-containing solid component a) preferably further comprises at least one halogen-containing magnesium compound. Here, halogens are chlorine, bromine, iodine or fluorine, with preference being given to bromine and in particular chlorine. The halogen-containing magnesium compounds are either used directly in the preparation of the titanium-containing solid component a) or are formed during its preparation. Magnesium compounds which are suitable for preparing the titanium-containing solid component a) are, in particular, the magnesium halides, especially magnesium dichloride or magnesium dibromide, or magnesium compounds from which the halides can be obtained in a customary manner by, for example, reaction with halogenating agents, e.g. magnesium alkyls, magnesium aryls, magnesium alkoxide or magnesium aryl oxide compounds or Grignard compounds. Preferred examples of halogen-free compounds of magnesium which are suitable for preparing the titanium-containing solid component a) are n-butylethylmagnesium or n-butyloctylmagnesium. Preferred halogenating agents are chlorine or hydrogen chloride. However, the titanium halides can also serve as halogenating agents.

In addition, the titanium-containing solid component a) advantageously further comprises electron donor compounds, for example monofunctional or polyfunctional carboxylic acids, carboxylic anhydrides or carboxylic esters, also ketones, ethers, alcohols, lactones or organophosphorus or organosilicon compounds.

As electron donor compounds within the titanium-containing solid component, preference is given to using carboxylic acid derivatives and in particular phthalic acid derivatives of the formula (II)

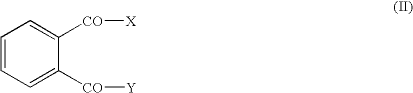

where X and Y are each a chlorine or bromine atom or a C₁-C₁₀-alkoxy radical or are together oxygen in an anhydride function. Particularly preferred electron donor compounds are phthalic esters in which X and Y are each a C₁-C₈-alkoxy radical. Examples of preferred phthalic esters are diethyl phthalate, di-n-butyl phthalate, diisobutyl phthalate, di-n-pentyl phthalate, di-n-hexyl phthalate, di-n-heptyl phthalate, di-n-octyl phthalate and di-2-ethylhexyl phthalate.

Further preferred electron donor compounds within the titanium-containing solid component are diesters of 3- or 4-membered, substituted or unsubstituted cycloalkyl-1,2-dicarboxylic acids, and also monoesters of substituted benzophenone-2-carboxylic acids or substituted benzophenone-2-carboxylic acids. Hydroxy compounds used for preparing these esters are the alkanols customary in esterification reactions, for example C₁-C₁₅-alkanols or C₅-C₇-cycloalkanols, which may in turn bear one or more C₁-C₁₀-alkyl groups, also C₆-C₁₀-phenols.

It is also possible to use mixtures of various electron donor compounds.

In the preparation of the titanium-containing solid component a), use is generally made of from 0.05 to 2.0 mol, preferably from 0.2 to 1.0 mol, of the electron donor compounds per mole of magnesium compound.

In addition, the titanium-containing solid component a) may further comprise inorganic oxides as supports. Use is generally made of a finely divided inorganic oxide having a mean particle diameter of from 5 to 200 μm, preferably from 20 to 70 μm, as support. For the present purposes, the mean particle diameter is the volume-based mean (median) of the particle size distribution determined by Coulter Counter analysis.

The particles of the finely divided inorganic oxide are preferably composed of primary particles having a mean diameter of from 1 to 20 μm, in particular from 1 to 5 μm. These primary particles are porous, granular oxide particles which are generally obtained by milling a hydrogel of the inorganic oxide. It is also possible to sieve the primary particles before they are processed further.

Furthermore, the inorganic oxide which is preferably used also has voids or channels which have a mean diameter of from 0.1 to 20 μm, in particular from 1 to 15 μm, and whose macroscopic proportion by volume in the total particle is in the range from 5 to 30%, in particular in the range from 10 to 30%.

The mean diameter of the primary particles and the macroscopic proportion by volume of the voids and channels of the inorganic oxide are advantageously determined by image analysis with the aid of scanning electron microscopy or electron probe microanalysis, in each case on particle surfaces and on particle cross sections of the inorganic oxide. The micrographs obtained are evaluated and the mean particle diameter of the primary particles and the macroscopic proportion by volume of the voids and channels are determined therefrom. Image analysis is preferably carried out by converting the electron micrographic data into a halftone binary image and digital evaluation by means of an appropriate EDP program, e.g. the software package Analysis from SIS.

The inorganic oxide which is preferably used can be obtained, for example, by spray drying the milled hydrogel, which is for this purpose mixed with water or an aliphatic alcohol. Such finely divided inorganic oxides are also commercially available.

Furthermore, the finely divided inorganic oxide usually has a pore volume of from 0.1 to 10 cm³/g, preferably from 1.0 to 4.0 cm³/g, and a specific surface area of from 10 to 1 000 m²/g, preferably from 100 to 500 m²/g. The figures quoted here are the values determined by mercury porosimetry in accordance with DIN 66133 and by nitrogen adsorption in accordance with DIN 66131.

It is also possible to use an inorganic oxide whose pH, i.e. the negative logarithm to the base 10 of the proton concentration, is in the range from 1 to 6.5, in particular in the range from 2 to 6.

Suitable inorganic oxides are, in particular, the oxides of silicon, aluminum, titanium or a metal of main group I or II of the Periodic Table. Particularly preferred oxides are aluminum oxide and magnesium oxide and also sheet silicates, especially silicon oxide (silica gel). It is also possible to use mixed oxides such as aluminum silicates or magnesium silicates.

The inorganic oxides used as supports have water present on their surface. This water is partly physically bound by adsorption and partly chemically bound in the form of hydroxyl groups. The water content of the inorganic oxide can be reduced or completely eliminated by thermal or chemical treatment. In the case of a chemical treatment, customary desiccants such as SiCl₄, chlorosilanes or aluminum alkyls are generally used. The water content of suitable inorganic oxides is from 0 to 6% by weight. Preference is given to using an inorganic oxide in the form in which it is commercially available without further treatment.

The magnesium compound and the inorganic oxide are preferably present in the titanium-containing solid component a) in such amounts that from 0.1 to 1.0 mol, in particular from 0.2 to 0.5 mol, of the magnesium compound are present per mole of the inorganic oxide.

In addition, C₁-C₈-alkanols such as methanol, ethanol, n-propanol, isopropanol, n-butanol, sec-butanol, tert-butanol, isobutanol, n-hexanol, n-heptanol, n-octanol or 2-ethylhexanol or mixtures thereof are generally used in the preparation of the titanium-containing solid component a). Preference is given to using ethanol.

The titanium-containing solid component can be prepared by methods known per se. Examples are described, for example, in EP-A 45 975, EP-A 45 977, EP-A 86 473, EP-A 171 200, GB-A 2 111 066, U.S. Pat. No. 4,857,613 and U.S. Pat. No. 5,288,824. The process known from DE-A 195 29 240 is preferably employed.

Apart from trialkylaluminums, suitable aluminum compounds b) include compounds of this type in which an alkyl group is replaced by an alkoxide group or by a halogen atom, for example by chlorine or bromine. The alkyl groups can be identical or different. Linear or branched alkyl groups are possible. Preference is given to using trialkylaluminum compounds whose alkyl groups each contain from 1 to 8 carbon atoms, for example trimethylaluminum, triethylaluminum, triisobutylaluminum, trioctylaluminum or methyldiethylaluminum or mixtures thereof.

In addition to the aluminum compound b), electron donor compounds c) such as monofunctional or polyfunctional carboxylic acids, carboxylic anhydrides or carboxylic esters, also ketones, ethers, alcohols, lactones and organophosphorus and organosilicon compounds are generally used as further cocatalysts. These electron donor compounds c) can be identical to or different from the electron donor compounds used for preparing the titanium-containing solid component a). Preferred electron donor compounds here are organosilicon compounds of the formula (I)

R¹ₙSi(OR²)₄₋ₙ (I)

where radicals R¹ are identical or different and are each a C₁-C₂₀-alkyl group, a 5- to 7-membered cycloalkyl group which may in turn be substituted by C₁-C₁₀-alkyl, a C₆-C₁₈-aryl or a C₆-C₁₈-aryl-C₁-C₁₀-alkyl group, radicals R² are identical or different and are each a C₁-C₂₀-alkyl group and n is 1, 2 or 3. Particular preference is given to compounds in which R¹ is a C₁-C₈-alkyl group or a 5- to 7-membered cycloalkyl group and R² is a C₁-C₄-alkyl group and n is 1 or 2.

Among these compounds, particular mention may be made of dimethoxydiisopropylsilane, dimethoxyisobutylisopropylsilane, dimethoxydiisobutylsilane, dimethoxydicyclopentylsilane, dimethoxyisopropyl-tert-butylsilane, dimethoxyisobutyl-sec-butylsilane and dimethoxyisopropyl-sec-butylsilane.

The cocatalysts b) and c) are preferably used in such an amount that the atomic ratio of aluminum from the aluminum compound b) to titanium from the titanium-containing solid component a) is from 10:1 to 800:1, in particular from 20:1 to 200:1, and the molar ratio of the aluminum compound b) to the electron donor compound c) is from 1:1 to 250:1, in particular from 10:1 to 80:1.

The titanium-containing solid component a), the aluminum compound b) and the electron donor compound c) which is generally used together form the Ziegler-Natta catalyst system. The catalyst constituents b) and c) can be introduced into the tube reactor together with the titanium-containing solid component a) or as a mixture or else in any order and can be subjected to the preactivation in this reactor.

It is also possible to use Ziegler-Natta catalyst systems based on metallocene compounds or on polymerization-active metal complexes in the process of the present invention.

For the purposes of the present invention, metallocenes are complexes of metals of transition groups of the Periodic Table with organic ligands, and these together with compounds capable of forming metallocenium ions give active catalyst systems. For use in the process of the present invention, the metallocene complexes are usually present in supported form in the catalyst system. Inorganic oxides are frequently used as supports. Preference is given to the above-described inorganic oxides which can also be used for the preparation of the titanium-containing solid component a).

Metallocenes which are customarily used contain titanium, zirconium or hafnium as central atoms, with preference being given to zirconium. In general, the central atom is bound via a π bond to at least one, as a rule substituted, cyclopentadienyl group and also to further substituents. The further substituents can be halogens, hydrogen or organic radicals, with preference being given to fluorine, chlorine, bromine or iodine or a C₁-C₁₀-alkyl group.

Preferred metallocenes contain central atoms which are bound via two π bonds to two substituted cyclopentadienyl groups, with particular preference being given to those in which substituents of the cyclopentadienyl groups are bound to both cyclopentadienyl groups. Very particular preference is given to complexes whose cyclopentadienyl groups are additionally substituted by cyclic groups on two adjacent carbon atoms.

Preferred metallocenes also include those which contain only one cyclopentadienyl group which is still substituted by a radical which is also bound to the central atom.

Examples of suitable metallocene compounds are

ethylenebis(indenyl)zirconium dichloride,

ethylenebis(tetrahydroindenyl)zirconium dichloride,

diphenylmethylene-9-fluorenylcyclopentadienylzirconium dichloride,

dimethylsilanediylbis(3-tert-butyl-5-methylcyclopentadienyl)zirconium dichloride,

dimethylsilanediylbis(2-methylindenyl)zirconium dichloride,

dimethylsilanediylbis(2-methylbenzindenyl)zirconium dichloride

dimethylsilanediylbis(2-methyl-4-phenylindenyl)zirconium dichloride,

dimethylsilanediylbis(2-methyl-4-naphthylindenyl)zirconium dichloride,

dimethylsilanediylbis(2-methyl-4-isopropylindenyl)zirconium dichloride or

dimethylsilanediylbis(2-methyl-4,6-diisopropylindenyl)zirconium dichloride and also the corresponding dimethylzirconium compounds.

The metallocene compounds are either known or can be obtained by methods known per se.

The metallocene catalyst systems further comprise compounds capable of forming metallocenium ions. Suitable compounds of this type are strong, uncharged Lewis acids, ionic compounds having Lewis-acid cations or ionic compounds having Brönsted acids as cation. Examples are tris(pentafluorophenyl)borane, tetrakis(pentafluorophenyl)borate or salts of N,N-dimethylanilinium. Further suitable compounds capable of forming metallocenium ions are open-chain or cyclic aluminoxane compounds. These are usually prepared by reacting trialkylaluminum with water and are generally in the form of mixtures of both linear and cyclic chain molecules of various lengths.

In addition, the metallocene catalyst systems may comprise organometallic compounds of metals of main group I, II or III of the Periodic Table, for example n-butyllithium, n-butyl-n-octylmagnesium or triisobutylaluminium, triethylaluminium or trimethylaluminium.

The process of the present invention can be used for preactivating catalysts which are used in the polymerization of C₂-C₂₀-olefins. The polymerization can be carried out in the gas phase, in the liquid phase, in the slurry phase or else in the bulk phase in at least one, frequently two or more, reaction zones connected in series (reactor cascade). The reaction conditions in the actual polymerization can also be set so that the respective monomers are present in two different phases, for example partly in the liquid state and partly in the gaseous state (condensed mode).

It is possible to use the customary reactors employed for the polymerization of C₂-C₂₀-olefins. Suitable reactors are, for example, continuously operated horizontal or vertical stirred reactors, circulation reactors, loop reactors, stage reactors or fluidized-bed reactors. The size of the reactors is not critical for the process of the present invention. It depends on the output which is to be achieved in the reaction zone or in the individual reaction zones.

In particular, fluidized-bed reactors and horizontally or vertically stirred powder-bed reactors are used as reactors. In the process of the present invention, the reaction bed generally comprises the polymer of C₂-C₂₀-olefins which is produced in the respective reactor.

In a particularly preferred embodiment of the process of the present invention, the polymerization is carried out in a reactor or cascade of reactors connected in series in which the pulverulent reaction bed is kept in motion by means of a vertical stirrer. Free-standing helical stirrers are particularly well suited for this purpose. Such stirrers are known, for example, from EP-B 000 512 and EP-B 031 417. They are particularly effective in distributing the pulverulent reaction bed very homogeneously. Examples of such pulverulent reaction beds are described in EP-B 038 478. The reactor cascade preferably comprises two tank reactors which are connected in series, are each provided with a stirrer and have a capacity of from 0.1 to 100 m³, for example 12.5, 25, 50 or 75 m³.

In the process of the present invention for preactivating catalysts for the polymerization of C₂-C₂₀-olefins, the catalyst is first mixed with the respective monomer, then, if appropriate, the respective cocatalyst is added and the resulting mixture is subsequently subjected to preactivation in a tube reactor. In the case of polymerization using Ziegler-Natta catalyst systems, this means that the titanium-containing solid component a) is firstly mixed with the respective monomers, after which any organic aluminum compounds b) and electron donor compounds c) used as cocatalysts are added. In the case of metallocene catalysts, the complex of metals of transition groups of the Periodic Table with organic ligands is, according to the process of the present invention, firstly mixed with the respective monomer, after which any cocatalyst to be used, for example aluminoxane compounds, is added to the mixture obtained. If a polymerization catalyst does not require a cocatalyst, the corresponding process step can, of course, be left out.

The mixture obtained is subsequently subjected to preactivation in a tube reactor, preferably at from −25 to 150° C., in particular from −15 to 100° C., pressures of from 1 to 100 bar, in particular from 10 to 60 bar, and mean residence times of the reaction mixture of from 1 to 5 minutes, in particular from 1 to 3 minutes. It may also be advisable to carry out a prepolymerization of the concomitantly introduced monomers by addition of suitable cocatalysts in the tube reactor.

The tube reactors used in the preactivation process of the present invention preferably have a length/diameter ratio of from 50 000:1 to 50:1, in particular from 10 000:1 to 100:1. As tube reactors, it is possible to use the tube reactors customary in polymer technology, for example continuous welded V_{2A} steel tubes or else weldable V_{2A} steel tube sections. Particularly in the case of very reactive catalysts, it may be advisable to use a tube reactor of this type which has a smooth, continuous liner tube without seams in its interior. Suitable materials for such a liner tube are, for example, plastic, metal, graphite or ceramic, in particular Teflon or ceramic-doped Teflon. Such a liner tube can, for example, prevent formation of deposits on the wall of the tube. Furthermore, the tube reactor can be provided at various points with a feed facility, for example to feed in additional monomers, catalysts, cocatalysts or additives.

In the process of the present invention, it is essential that the mixture of catalysts, any cocatalyst and monomer is passed through the tube reactor in turbulen plug flow at a Reynolds number of at least 2 300, in particular at least 5 000, based on pure propylene, and is preactivated in this reactor. The Reynolds number is a parameter characterizing flow phenomena in pipes by defining the ratio of inertial to frictional forces in flowing liquids according to equation (III) below:

$$RE = \frac{2 R \cdot ν \cdot ς}{η} \qquad ( III )$$

In the equation (III),

R: the radius of the tube through which flow occurs

ν: the mean flow velocity

ζ: the density of the liquid to be measured and

η: the dynamic viscosity of the liquid to be measured.

To avoid blockages in the tube reactor, it may also be advisable to introduce the catalyst and any cocatalyst into the tube reactor via a suitable homogenization unit so as to ensure a homogeneous catalyst concentration and thus control heat removal at all times during the preactivation. Suitable homogenization units are, inter alia, countercurrent nozzles, axial mixers, laminar flow mixers, static mixers and other customary industrial mixers. Depending on the catalyst used, the temperature of the monomer used and also the corresponding gas mixture can likewise be varied. To achieve a smooth surface, the interior of the homogenization unit can also be provided with a liner of metal, plastic or ceramic, with plastic liners being preferred. It is also possible to use an upstream catalyst metering apparatus, for example a metering apparatus customary in the polymerization of olefins, e.g. a dimple feeder, a double check feeder or metering pumps. The catalyst can be fed in, for example, as a solid or else as a suspension, for example in the liquid monomer or else in hydrocarbons such as heptane or isododecane.

According to the process of the present invention, the preactivated catalyst is subsequently introduced into the corresponding polymerization reactor where the actual polymerization of the C₂-C₂₀-olefins takes place.

In the process of the present invention, the actual polymerization is carried out under customary reaction conditions at from 40 to 150° C. and pressures of from 1 to 100 bar. Preference is given to temperatures of from 40 to 120° C., in particular from 60 to 100° C., and pressures of from 10 to 50 bar, in particular from 20 to 40 bar. The molar mass of the C₂-C₂₀-olefin polymers formed can be controlled and set by addition of regulators customary in polymerization technology, for example hydrogen. Apart from molar mass regulators, it is also possible to use activity regulators, i.e. compounds which influence the catalyst activity, and/or antistatics. The latter prevent formation of deposits on the reactor wall as a result of electrostatic charging. The polymers of the C₂-C₂₀-olefins generally have a melt flow rate (MFR) of from 0.1 to 3 000 g/10 min, in particular from 0.2 to 100 g/10 min, at 230° C. under a weight of 2.16 kg. The melt flow rate corresponds to the amount of polymer which is pressed out from the test apparatus standardized in accordance with ISO 1133 over a period of 10 minutes at 230° C. under a weight of 2.16 kg. Particular preference is given to polymers whose melt flow rate is from 5 to 50 g/10 min at 230° C. under a weight of 2.16 kg.

In the process of the present invention, the mean residence times in the actual polymerization of the C₂-C₂₀-olefins are in the range from 0.1 to 10 hours, preferably in the range from 0.2 to 5 hours and in particular in the range from 0.3 to 4 hours.

In an embodiment of the process of the present invention for preactivation catalysts, it is also possible to meter monomer, catalyst, any cocatalyst and auxiliaries, for example hydrogen, both into the tube reactor and also into the actual polymerization reactor. In this way, it is possible to control the process at various points.

The process of the present invention for preactivating catalysts for the polymerization of C₂-C₂₀-olefins makes it possible, inter alia, to improve the reactor stability, the space-time yield and the productivity of the polymerization processes. Furthermore, the polymerization of the C₂-C₂₀-olefins can be controlled significantly better by means of the increased introduction possibilities of monomers, catalyst, any cocatalyst and regulators. In addition, a reduction in the formation of deposits and lumps in the polymerization reactor and a significant improvement in the morphology of the C₂-C₂₀-olefin polymers obtained as a result of reduction of the fine dust content and a narrower particle size distribution are observed. The resulting polymers of C₂-C₂₀-olefins also display a better product homogeneity. The process of the present invention can be carried out inexpensively in industry and is easy to control.

The process of the present invention can be carried out in the apparatus which is likewise subject matter of the present invention. This comprises, inter alia, feed facilities for metering in the catalyst, any cocatalyst and the monomer, optionally an attached homogenization apparatus, optionally a further feed facility for the cocatalyst and, connected thereto, a tube reactor whose output is connected to a polymerization reactor. The apparatus can also be configured so that further feed facilities for monomers, catalysts, any cocatalyst and auxiliaries are located on the polymerization reactor. Furthermore, the tube reactor can be provided with a smooth, continuous liner tube without seams.

The process of the present invention and the apparatus of the present invention allow the preparation of various types of polymers of C₂-C₂₀-olefins, for example homopolymers, copolymers or mixtures of such polymers. These are suitable, in particular, for producing films, fibers or moldings.

### EXAMPLES

The experiments of examples 1, 2 and the comparative example A were carried out using a Ziegler-Natta catalyst system comprising a titanium-containing solid component a) prepared by the following method.

In a first step, a finely divided silica gel having a mean particle diameter of 30 μm, a pore volume of 1.5 cm³/g and a specific surface area of 260 m²/g was admixed with a solution of n-butyloctylmagnesium in n-heptane, using 0.3 mol of the magnesium compound per mole of SiO₂. The finely divided silica gel additionally had a mean particle size of the primary particles of 3-5 μm and voids and channels having a diameter of 3-5 μm, with the microscopic proportion by volume of the voids and channels in the total particle being about 15%. The mixture was stirred for 45 minutes at 95° C., then cooled to 20° C., after which 10 times its molar amount, based on the organomagnesium compound, of hydrogen chloride was passed into it. After 60 minutes, the reaction product was admixed with 3 mol of ethanol per mole of magnesium while stirring continuously. This mixture was stirred at 80° C. for 0.5 hours and subsequently admixed with 7.2 mol of titanium tetrachloride and 0.5 mol of di-n-butyl phthalate, in each case based on 1 mol of magnesium. The mixture was subsequently stirred at 100° C. for 1 hour, and the solid obtained in this way was filtered off and washed a number of times with ethylbenzene.

The solid product obtained was extracted at 125° C. with a 10% strength by volume solution of titanium tetrachloride in ethylbenzene for 3 hours. The solid product was then separated from the extractant by filtration and washed with n-heptane until the washings contained only 0.3% by weight of titanium tetrachloride.

The titanium-containing solid component a) comprises

3.5% by weight of Ti

7.4% by weight of Mg

28.2% by weight of Cl.

In addition to the titanium-containing solid component a), triethylaluminum and organic silane compounds were used as cocatalysts in a manner analogous to the teachings of U.S. Pat. No. 4,857,613 and U.S. Pat. No. 5,288,824.

### Example 1

The polymerization was carried out in a vertically mixed gas-phase reactor having a utilizable capacity of 200 l and equipped with a free-standing helical stirrer (87 rpm). The reactor contained an agitated solid bed comprising 45 kg of finely divided polymer. The reactor pressure was 32 bar. The titanium-containing solid component a) was used as catalyst.

Firstly, propylene as monomer was mixed with the catalyst, i.e. the titanium-containing solid component a). The catalyst was metered in at room temperature together with the fresh propylene added to regulate the pressure. The amount of catalyst metered in was set so that the mean output of 45 kg of polypropylene per hour was maintained. The catalyst/propylene mixture was metered in via a dimple feeder having lateral depressurization, depressurization cyclone in the off-gas line and pulsed nitrogen flushing. The catalyst/propylene suspension was subsequently transferred by means of a flexible feed line (dᵢₙₜₑᵣₙₐₗ=6 mm) from above into a cylindrical vessel (a homogenization apparatus) whose interior walls were polished (dᵢₙₜₑᵣₙₐₗ=100 mm, l=375 mm). After homogenization of the pulsed catalyst shot, the propylene/catalyst mixture was transferred continuously into a pressure-rated tube reactor containing a loose continuous Teflon tube (l_{tube reactor}=100 m, dᵢₙₜₑᵣₙₐₗ(Teflon tube)=6 mm). A mixture of triethylaluminum (in the form of a 1 molar heptane solution) in an amount of 135 mmol/h and 13.5 mmol/h of dicyclopentyldimethoxysilane (in the form of a 0.125 molar heptane solution) was metered into the gas-phase reactor. To regulate the molar mass, hydrogen was metered into the circulating gas cooler. The hydrogen concentration in the reaction gas was 3.3% by volume and was determined by gas chromatography. In the tube reactor, the mixture of catalyst and propylene was briefly preactivated at 20° C., a pressure of 40 bar and a mean residence time of 1.6 minutes and then flushed into the gas-phase reactor. The mixture of catalyst and propylene flowed through the tube reactor at a Reynolds number of 32 400, based on the propylene.

The catalyst which had been preactivated in this way was subsequently transferred together with the propylene into the gas-phase reactor and polymerized there.

The heat produced in the polymerization in the gas-phase reactor was removed by evaporative cooling. For this purpose, a gas stream corresponding to from 4 to 6 times the amount of gas reacted was circulated. The vaporized propylene was taken off at the top of the reactor after passing through the reaction zone, separated from entrained polymer particles in a circulating gas filter and condensed by secondary water in a heat exchanger. The condensed circulating gas was pumped back at up to 40° C. into the reactor. The hydrogen which could not be condensed in the condenser was drawn off and fed back into the liquid circulating gas stream from below. The temperature in the reactor was regulated by means of the flow of circulating gas and was 80° C., the pressure was 32 bar.

Polymer powder was removed from the reactor at intervals via an immersed tube by brief depressurization of the reactor. The discharge frequency was regulated by means of a radiometric fill level measurement. This setting was maintained in a stable fashion for a total of 75 hours and was subsequently switched off in a controlled manner. A propylene homopolymer having a melt flow rate (MFR) in accordance with ISO 1133 of 12.2 g/10 min was obtained.

The process parameters in the gas-phase reactor and characteristic product properties of the polymer obtained are shown in table I below.

### Example 2

The polymerization in the continuously operated 200 l gas-phase reactor was carried out in a manner analogous to example 1. The catalyst was metered in in a manner analogous to example 1. The mixture of triethylaluminum (in the form of a 1 molar heptane solution) in an amount of 135 mmol/h and 13.5 mmol/h of dicyclopentyldimethoxysilane (in the form of a 0.125 molar heptane solution) was metered in via an injection line (dᵢₙₜₑᵣₙₐₗ=2 mm) directly into the start of the tube reactor with Teflon liner. The amount of fresh propylene was divided so that 80% by mass of the fresh propylene were introduced into the tube reactor together with the catalyst (titanium-containing solid component a)) and 20% by mass of the fresh propylene were introduced together with the heptane solutions of triethylaluminum and dicyclopentyldimethoxysilane. In the tube reactor, the mixture of catalyst, cocatalyst and propylene was conveyed at a Reynolds number of about 32 400 in the direction of the end of the tube and the propylene was prepolymerized during passage through the tube reactor. This setting was maintained in a stable fashion over a total of 75 hours and was subsequently switched off in a controlled manner. In the tube reactor, the prepolymerization took place at a pressure of 40 bar and a mean residence time of 1.6 minutes. The catalyst which had been preactivated in this way was subsequently transferred together with the propylene polymer already formed and the unreacted propylene into the gas-phase reactor and the polymerization was continued there.

The process parameters in the gas-phase reactor and characteristic product properties of the polymer obtained are shown in table I below.

### Comparative Example A

The polymerization in the continuously operated 200 l gas-phase reactor was carried out in a manner analogous to example 1. The catalyst/propylene mixture was metered in at the side of the reactor via a dimple feeder having lateral depressurization, a cyclone in the off-gas line and a pulsed nitrogen flushing. The triethylaluminum and dicyclopentyldimethoxysilane were metered directly into the gas-phase reactor.

In contrast to example 1, the brief preactivation in the tube reactor was omitted in comparative example A. The setting was maintained in a stable fashion for a total of 75 hours and subsequently switched off in a controlled manner. The process parameters in the gas-phase reactor and the characteristic product properties of the polymer obtained are shown in table I below.

TABLE I

| | | | Comparative |
|---|---|---|---|
| | Example 1 | Example 2 | example A |
| Reactor pressure [bar] | 32 | 32 | 32 |
| Reactor temperature [° C.] | 80 | 80 | 80 |
| Stirrer speed [rpm] | 87 | 87 | 87 |
| Mean residence time [min] | | | |
| Tube reactor | 1.6 | 1.6 | — |
| Gas-phase reactor | 60 | 60 | 60 |
| Hydrogen [% by volume] | 3.3 | 3.2 | 3.4 |
| MFR [g/min] | 12.2 | 12.3 | 12.3 |
| Productivity [g of PP/g of cat] | 16 200 | 22 700 | 15 500 |
| Polymer powder morphology | | | |
| <0.125 mm [%] | 4.0 | 2.1 | 11.4 |
| <0.25 mm [%] | 8.4 | 2.1 | 11.1 |
| <0.5 mm [%] | 20.4 | 9.5 | 21.4 |
| <1.0 mm [%] | 46.7 | 36.1 | 32.8 |
| <2.0 mm [%] | 20.1 | 46.5 | 22.1 |
| >2.0 mm [%] | 0.4 | 0.4 | 1.2 |

The melt flow rate (MFR) was determined at 230° C. and a weight of 2.16 kg in accordance with ISO 1133 and the polymer powder morphology was determined by sieve analysis. The productivity was calculated from the chlorine content of the polymers obtained according to the following formula:

Productivity (P)=Cl content of the catalyst/Cl content of the polymer

The propylene homopolymers obtained in example 2 according to the present invention and comparative example A were additionally subjected to a melt filtration test.

In the melt filtration test, the polymer melt is pushed at 265° C. through a sieve having a mesh opening of 5 μm and an area of 434 mm² by means of an extruder for 60 minutes at a pressure such that the throughput is 2 kg/h. The presence of particles which had not been melted and/or inorganic particles result, at constant throughput, in a steady increase in the measured melt pressure. The results of the melt filtration test on the polymers from example 2 and comparative example A are summarized in table II.

TABLE II

| | Melt pressure [bar] | Melt pressure [bar] |
|---|---|---|
| Running time [min] | Example 2 | Comparative example A |
| 5 | 86 | 84 |
| 10 | 86 | 87 |
| 15 | 86 | 90 |
| 20 | 87 | 93 |
| 25 | 87 | 96 |
| 30 | 88 | 99 |
| 35 | 89 | 104 |
| 40 | 89 | 110 |
| 45 | 89 | 119 |
| 50 | 90 | 126 |
| 55 | 91 | 138 |
| 60 | 92 | 147 |

The results of the melt filtration test show that the process of the present invention gives polymers which are more homogeneous than corresponding polymers which have been obtained by conventional processes.

The experiments of examples 3, 4 and the comparative example were carried out using a metallocene catalyst which had been prepared as follows:

0.98 kg (1.7 mol) of rac. dimethylsilylenebis(2-methyl-benz[e]indenyl)zirconium dichloride were placed under nitrogen in a 300 l stirred vessel and were dissolved at room temperature while stirring in 124 kg of 1.53 molar (based on Al) MAO solution (from Witco; 10% by weight of methylaluminoxane in toluene). Two thirds of the solution obtained in this way were sprayed over a period of 3 hours onto the chemically dried silica gel which had been placed in the process filter with as even a surface as possible, with the outlet of the process filter remaining open. The last third of the solution was no longer sprayed on, but was added directly from above to the supernatant solution without stirring up the support on the filter. After addition of all of the solution, the outlet was closed. On the next day, the outlet was open again and the remaining solution was filtered off firstly without application of pressure and then, toward the end, under a slight nitrogen overpressure. 60 l of pentane were sprayed onto the solid which remained and the mixture was stirred for 1 hour. After filtration, the solid was washed twice with 60 l each time of pentane and the supported catalyst which remained was then dried in a stream of nitrogen (2 hours at an internal temperature of 35-40° C. and very slow stirring). The yield was 34.8 kf supported metallocene catalyst.

### Example 3

The polymerization was carried out in a vertically mixed gas-phase reactor having a utilizable capacity of 200 l and equipped with a free-standing helical stirrer (95 rpm). The reactor contained an agitated fixed bed comprising 45 kg of finely divided polymer. The reactor pressure was 28 bar. The above-described metallocene catalyst was used as catalyst. Such metallocene catalysts are already polymerization-active in the presence of monomer. The catalyst was metered in at −5° C. as a suspension in isododecane together with the fresh propylene added before regulating the pressure. Before introduction of the catalyst, 20 mmol/h of isopropanol (in the form of a 0.5 molar heptane solution) were added to the fresh propylene. The amount of catalyst metered in was set so that the mean output of 20 kg of polypropylene per hour was maintained. The catalyst/fresh propylene mixture was metered in via a dimple feeder having lateral depressurization, a depressurization cyclone in the off-gas line and pulsed nitrogen flushing. The catalyst/fresh propylene suspension was subsequently transferred by means of a flexible feed line (Dᵢₙₜₑᵣₙₐₗ=6 mm) from above into a cylindrical vessel whose interior walls were polished (dᵢₙₜₑᵣₙₐₗ=100 mm; l=375 mm). After homogenization of the pulsed catalyst shot, the propylene/catalyst mixture was transferred continuously into a pressure-rated tube reactor provided with a loose continuous Teflon tube (l_{tube reactor}=50 m, dᵢₙₜₑᵣₙₐₗ(Teflon tube)=6 mm). Triisobutylaluminum (in the form of a 2 molar heptane solution) was metered into the gas-phase reactor in an amount of 60 mmol/h.

In the tube reactor, the propylene/catalyst mixture was introduced at −5° C., a pressure of 38 bar and a mean residence time of 1.5 minutes into the gas-phase reactor and prepolymerized there. The mixture of catalyst and propylene flowed through the tube reactor at a Reynolds number of about 17 500, based on the propylene.

The catalyst which had been preactivated in this way was subsequently transferred together with the propylene polymer already formed and the unreacted propylene into the gas-phase reactor and the polymerization was continued there.

The reaction heat produced in the polymerization was removed by evaporative cooling. For this purpose, a gas stream corresponding to from 4 to 6 times the amount of gas reacted was circulated. The vaporized propylene was taken off at the top of the reactor after passing through the reaction zone, separated from entrained polymer particles in a circulating gas filter and condensed by secondary water in a heat exchanger. The condensed circulating gas was pumped back at up to 40° C. into the reactor. The temperature in the reactor was regulated by means of the flow of circulating gas and was 70° C.

Polymer powder was removed from the reactor at intervals via an immersed tube by brief depressurization of the reactor. The discharge frequency was regulated by means of a radiometric fill level measurement. This setting was maintained in a stable fashion for a total of 75 hours and was subsequently switched off in a controlled manner.

The process parameters in the gas-phase reactor and characteristic product properties of the polymer obtained are shown in table III below.

### Example 4

The polymerization in the continuous 200 l gas-phase reactor was carried out in a manner analogous to example 3. The catalyst was metered in in a manner analogous to example 3.

Triisobutylaluminum (in the form of a 2 molar heptane solution) in an amount of 60 mmol/h was metered in via an injection line (dᵢₙₜₑᵣₙₐₗ=2 mm) directly into the start of the tube reactor with Teflon liner. The amount of fresh propylene was divided so that 80% by mass of the fresh propylene were introduced into the tube reactor together with the catalyst and 20% by mass of the fresh propylene were introduced together with the triisobutylaluminum/heptane solution.

This setting was maintained in a stable fashion for a total of 75 hours and was subsequently switched off in a controlled manner. The catalyst which had been preactivated in this way was subsequently transferred together with the propylene polymer already formed and the unreacted propylene into the gas-phase reactor and the polymerization was continued there.

The process parameters in the gas-phase reactor and the characteristic product properties of the polymer obtained are shown in table III below.

### Comparative Example B

The polymerization in the continuous 200 l gas-phase reactor was carried out in a manner analogous to example 3 and example 4. The catalyst/fresh propylene/isopropanol mixture was metered in at the side of the reactor via a dimple feeder having lateral depressurization, a cyclone in the off-gas line and pulsed nitrogen flushing. Triisobutylaluminum was metered in in a manner analogous to example 3.

This setting was maintained in a stable fashion over a total of 75 hours and was subsequently switched off in a controlled fashion. In contrast to example 3, the preactivation in the tube reactor was omitted in comparative example B.

The process parameters and the characteristic product properties of the polymer obtained are shown in table III below.

TABLE III

| | | | Comparative |
|---|---|---|---|
| | Example 3 | Example 4 | example B |
| Reactor pressure [bar] | 28 | 28 | 28 |
| Reactor temperature [° C.] | 70 | 70 | 70 |
| Stirrer speed [rpm] | 95 | 95 | 95 |
| MFR [g/min] | 7.4 | 7.2 | 8.4 |
| Productivity [g of PP/g of cat] | 7800 | 9100 | 6900 |
| Polymer particle morphology: | | | |
| <0.125 mm [%] | 0.1 | 0.2 | 0.3 |
| <0.25 mm [%] | 0.5 | 0.6 | 0.6 |
| <0.5 mm [%] | 4.6 | 8.0 | 3.6 |
| <1.0 mm [%] | 25.4 | 11.5 | 38.0 |
| <2.0 mm [%] | 64.1 | 76.8 | 48.4 |
| >2.0 mm [%] | 5.3 | 2.9 | 9.1 |

The melt flow rate (MFR) was determined at 230° C. and a weight of 2.16 kg in accordance with ISO 1133 and the polymer particle morphology was determined by sieve analysis. The productivity was calculated from the chlorine content of the polymers obtained according to the following formula:

Productivity (P)=Cl content of the catalyst/Cl content of the polymer

We claim:

1. A process for preactivating catalysts for the polymerization of C₂-C₂₀-olefins, in which the catalyst is first mixed with the respective monomer, then, if appropriate, the respective cocatalyst is added and the resulting mixture is subsequently subjected to preactivation in a tube reactor and the catalyst which has been preactivated in this way is finally introduced into the actual polymerization reactor, wherein the mixture of catalyst, any cocatalyst and monomer is passed through the tube reactor in turbulent plug flow at a Reynolds number of at least 2 300.

2. A process as claimed in claim 1, wherein the mixture of catalyst, any cocatalyst and monomer is passed through the tube reactor in turbulent plug flow at a Reynolds number of at least 5 000.

3. A process as claimed in claim 1 or 2, wherein the tube reactor used has a smooth, continuous liner tube without seams in its interior.

4. A process as claimed in any of claims 1 to 3, wherein the mixture is passed through the tube reactor at from −25 to 150° C., pressures of from 1 to 100 bar and mean residence times of from 1 to 5 minutes.

5. A process as claimed in any of claims 1 to 4 used in the production of homopolymers of propylene.

6. A process as claimed in any of claims 1 to 5 used in the production of copolymers of propylene with subordinate amounts of other C₂-C₂₀-olefins.

7. A process as claimed in any of claims 1 to 6, wherein the mixture of catalyst, monomer and cocatalyst is subjected to a prepolymerization in the tube reactor.

8. A process as claimed in any of claims 1 to 7, wherein the polymerization of the C₂-C₂₀-olefins is carried out by means of a Ziegler-Natta catalyst comprising a titanium-containing solid component a) together with cocatalysts in the form of organic aluminum compounds b) and electron donor compounds c).

9. A process as claimed in any of claims 1 to 8, wherein the polymerization of the C₂-C₂₀-olefins is carried out by means of a Ziegler-Natta catalyst based on metallocene compounds or on polymerization-active metal complexes.

10. A process as claimed in any of claims 1 to 9, wherein the actual polymerization reactor used is a vertial, stirred gas-phase reactor.

11. An apparatus for preactivating catalysts for the polymerization of C₂-C₂₀-olefins, comprising feed facilities for metering in the catalyst, any cocatalyst and the monomer, optionally an attached homogenization apparatus, optionally a further feed facility for the cocatalyst and, connected thereto, a tube reactor whose output is connected to a polymerization reactor.

12. An apparatus as claimed in claim 11, wherein the tube reactor used has a smooth, continuous liner tube without seams in its interior.
